(19) United States
(12) Patent Application Publication
(10) Pub. No.: US 2014/0030603 A1
(43) Pub. Date: Jan. 30, 2014

(54) ELECTRODE FOR AN ELECTROCHEMICAL ENERGY STORE AND METHOD FOR MANUFACTURING SAME

(71) Applicants: Marcus Wegner, Leonberg (DE); Jean Fanous, Stuttgart (DE)

(72) Inventors: Marcus Wegner, Leonberg (DE); Jean Fanous, Stuttgart (DE)

(73) Assignee: ROBERT BOSCH GMBH, Stuttgart (DE)

(21) Appl. No.: 13/952,889

(22) Filed: Jul. 29, 2013

(30) Foreign Application Priority Data
Jul. 27, 2012 (DE) 10 2012 213 219.8

(51) Int. Cl. H01M 4/137; H01M 4/62; H01M 4/1399; H01M 4/04

(52) U.S. Cl. CPC H01M 4/137; H01M 4/0404; H01M 4/625; H01M 4/1399
USPC 429/232; 427/58; 252/500

(57) ABSTRACT

An electrode for an electrochemical energy store, in particular a cathode for a lithium-sulfur battery. To obtain a particularly good rate capability, the electrode includes an electrically conductive matrix, in particular having a binder and a conductive additive. Locally delimited active areas are situated in the electrically conductive matrix, and the active areas have an active material, a conductive additive, and a binder. Moreover, an energy store is provided, such as a lithium-sulfur battery in particular, and a method for manufacturing an electrode is also provided.

### CROSS REFERENCE

The present application claims the benefit under 35 U.S.C. §119 of German Patent Application No. DE 102012213219.8 filed on Jul. 27, 2012, which is expressly incorporated herein by reference in its entirety.

### FIELD

The present invention relates to an electrode for an electrochemical energy store and a method for manufacturing an electrode for an electrochemical energy store. Moreover, the present invention relates to a lithium-based energy store, such as in particular a primary or secondary lithium battery, for example a lithium metal battery or lithium-ion battery.

### BACKGROUND INFORMATION

Lithium-ion batteries and lithium batteries are prevalent in many everyday applications. They are used, for example, in computers such as laptops, mobile telephones, smart phones, and in other applications. These types of batteries also offer advantages in the present strong impetus for electrification of vehicles such as motor vehicles. However, lithium batteries in present use have, for example, an energy content which for an appropriate battery weight may have limited ranges of 200 km, for example. Lithium-sulfur technologies, for example, are a promising variant for enabling further improvements. Conventional lithium-sulfur cells may, for example, supply energy densities of approximately 350 Wh/kg, for example, which may be considerably above that of conventional cells (approximately 200 Wh/kg).

At the present time, however, the service life of lithium-sulfur cells may be limited to 100 complete cycles, for example. One reason in particular may be considered to be the path diffusion of the polysulfides from the cathode and the reaction of same at the lithium metal anode. Improved specific embodiments of lithium-sulfur in which the sulfur utilization is significantly increased are based, for example, on the fact that sulfur is bound to cyclized polyacrylonitrile, and that a polyacrylonitrile-sulfur composite may be used as the active material.

### SUMMARY

In accordance with an example embodiment of the present invention, an electrode for an electrochemical energy store is provided, in particular a cathode for a lithium-sulfur battery, which includes an electrically conductive matrix in particular having a binder and a conductive additive, locally delimited active areas being situated in the electrically conductive matrix, and the active areas having a binder, a conductive additive, and an active material.

Within the meaning of the present invention, an energy store may in particular be any battery. In particular, in addition to a primary battery, an energy store may in particular be a secondary battery, i.e., a rechargeable accumulator. For example, an energy store may in particular be a lithium-based energy store. A lithium-based energy store includes, for example, lithium batteries as well as lithium-ion batteries. Lithium batteries, as opposed to lithium-ion batteries, usually include an anode made of metallic lithium or a metallic lithium alloy. In contrast, lithium-ion batteries may in particular include an anode, made of graphite, for example, in which lithium ions are intercalated. For example, the energy store is a lithium-sulfur battery.

Within the meaning of the present invention, an electrically conductive matrix may be understood in particular to mean a base structure or a base material in which one or multiple further elements or materials may be situated or embedded in a defined manner. The matrix may be electrically conductive in particular when it has an electrical conductivity that is in a range of greater than or equal to 10⁻³ S/cm.

Within the meaning of the present invention, an active area may be understood in particular to mean a locally delimited space or area, or a material combination which may be used for the electrochemical reactions which take place in an electrochemical energy store. For this purpose, the active area includes in particular the active material. The active area or the active areas is/are locally delimited, and may thus in particular be homogeneously distributed over the entire electrode; however, each active area itself may have only one delimited extension.

An electrode, having a design as described above, for an energy store may in particular provide a high energy content, and at the same time may provide a high rate capability.

Specifically, an electrode having a design as described above is suitable in particular for a function as a cathode in a lithium battery, for example a lithium-sulfur battery. This type of electrode includes an electrically conductive matrix. The electrically conductive matrix may, for example, be designed in a conventional manner by use of a binder in which in particular a conductive additive is provided. The binder may be used, in a conventional manner, to hold the components in question together, and may include, for example, a polymer such as polyvinylidene fluoride (PVDF), polyvinylidene hexafluoropropylene (PVDF-HFP), polytetrafluoroethylene (PTFE), polyethylene oxide (PEO), or carboxymethylcellulose (CMC)/styrene-butadiene rubber (SBR). The conductive additive for improving the electrical conductivity or for improving the electrical transport may likewise be a conventional electrically conductive material, in particular an electrically conductive carbon compound. Examples include graphite and/or carbon black.

In an electrode having a design as described above, a plurality of active areas is situated in the electrically conductive matrix. The active areas contain the active material, and may thus participate directly in the reaction which proceeds in the electrochemical energy store for generating energy, i.e., in a charging and/or discharging process. For example, for the case of a lithium-sulfur battery strictly as an example, the active areas may contain sulfur or a sulfur compound such as sulfur polymers or sulfur-polymer composites in particular as the active material. The spatially delimited active areas contain the active material in such a way that the active material is embedded in a binder and a conductive additive. In this case as well, the binder may also be used to hold the components in question together in a conventional manner, and may include, for example, polyvinylidene fluoride (PVDF), polyvinylidene hexafluoropropylene (PVDF-HFP), polytetrafluoroethylene (PTFE), polyethylene oxide (PEO), or carboxymethylcellulose (CMC)/styrene-butadiene rubber (SBR). The conductive additive may likewise be an electrically conductive material which is known per se, in particular an electrically conductive carbon compound. Examples include graphite and/or carbon black. As a result of the active areas also being present in a locally delimited or spatially delimited manner and containing the active material, the active areas may be understood, for example, as a plurality of small or very small electrodes which form the overall electrode in the totality of all active areas in the electrically conductive matrix. Thus, the electrode contains a matrix in which a plurality of spatially delimited active centers or small (partial) electrodes is situated.

Due to this type of spatially delimited extension having in particular small dimensions, for example, the rate capability of an energy store equipped with an electrode of this type of electrode may be significantly improved. For example, the quick charging capability of a battery may be improved as the result of a good rate capability.

The above-described advantage of an improved rate capability, for example, may be based on the small diffusion paths for ions, such as in particular lithium ions for the case of use in a lithium-sulfur battery as an example, in the electrode structure. Specifically, during the charging operation, lithium ions are transported through the electrolyte to the active material in the active areas. Since the reduction of the active material or the sulfur contained in the active material takes place in the solid matter, for example, the ion migration must occur through the active areas. Thus, by providing a plurality of active areas having a small diameter, a small diffusion length may be achieved, which in turn may result in higher discharge and charge rates. In addition, the improved rate characteristic may be based in particular on an enlarged surface of the small partial cathodes, as well as providing a conductive additive, and thus, improved electrical transport to or away from the active material.

In addition, due to the smaller diffusion paths and the improved electrical transport/conductivity, the overvoltage which occurs may be lower. These types of electrodes may thus counteract the effect that the voltage level of a battery may increase at higher charging currents, and the voltage level of a battery may decrease at higher discharging currents. In principle, the difference from the nominal voltage should be as small as possible. This may be achieved by the low overvoltage, which is made possible by the above-described electrode.

Due to an improvement in the rate capability, the overvoltage is reduced, so that a high energy density or capacitance may be maintained, even at higher rates.
In addition, in this type of electrode the desired rate capability and the improvement thereof may be controlled in a defined manner via the design or the configuration of the active areas. The performance data are thus easily controllable via the manufacturing process.

Within the scope of one embodiment, the active material may contain a polyacrylonitrile-sulfur composite. A polyacrylonitrile-sulfur (SPAN) composite may be understood in particular to mean a composite material that is produced by reacting polyacrylonitrile (PAN) with sulfur (S). For these types of composite materials, with regard to the structure there are references to a sulfur-carbon bond which fixedly bonds the polysulfides to the polymer matrix. This type of composite material is a sulfur-polyacrylonitrile composite having various functional groups and chemical bonds, which may all have different properties and contributions with regard to electrochemical performance and aging behavior. This type of active material may thus be adapted to the desired application in a particularly advantageous way.

The polyacrylonitrile-sulfur composite, in which the sulfur is fixedly bound to a polymer structure in particular in the subnanometer/nanometer range and/or may be finely or homogeneously distributed in the structure, has very good cycling stability and a high sulfur utilization rate.

This type of composite material as an active material may also allow in particular the advantage of a defined structure and a high discharge rate (C-rate), which in particular may particularly advantageously be suited for producing an active material for a cathode in an electrochemical energy store, in particular a lithium-sulfur battery. In this embodiment, the additional advantage may be achieved that this type of composite material experiences a lower drop in capacitance for large current intensities; i.e., a particularly stable capacitance may be obtained.

This type of composite material as the active material for a cathode of a lithium battery, for example, is particularly easily producible, since in particular the use of complicated, multistep syntheses may be dispensed with. Instead, this type of active material is producible in a particularly simple and cost-effective manner, so that an electrode or battery equipped with the composite material may also be manufacturable in a particularly cost-effective manner. In addition, by improving the rate capability, the overvoltage may be reduced for polyacrylonitrile-sulfur composite materials, so that a high energy density and capacitance may be maintained, even at higher rates.

Within the scope of another embodiment, a nanoscale electrically conductive carbon compound may be provided in the active areas; in particular, the nanoscale carbon compound may be in particular chemically bound to the polyacrylonitrile-sulfur composite.

This type of carbon compound may be used in the active material in particular as a conductive additive, previously described, which may be advantageous, since, for example, sulfur or a similar active material often has only limited electrical conductivity. Thus, by providing this type of conductive additive, the rate capability of an energy store equipped with such an electrode may be further improved in this embodiment. The use of nanoscale carbon compounds may provide the further advantage that these types of conductive additives may also be usable in a plurality of active areas having in particular small dimensions and having a small extension, without changes in the structure and with a free choice of the geometry. These types of conductive additives may be present finely distributed in the active material, or may be fixedly bound thereto, for example via chemical bonds such as covalent bonds.

Within the scope of the present invention, a nanoscale compound may be understood in particular to mean a compound which has a dimension in at least one plane in a nanometer range, for example, of less than or equal to 1000 nm, in particular less than or equal to 500 nm, for example less than or equal to 100 nm, these ranges being non-limiting.

Within the scope of another embodiment, the nanoscale carbon compound may contain graphene, carbon nanotubes, and/or carbon nanofibers. These types of carbon compounds are particularly suited for improving the conductivity of the active material, and thus for positively influencing the rate capabilities. Graphene, for example, is in particular a planar layer of carbon atoms bonded by sp² hybridization and arranged in dense packing, for example in a honeycomb-like structure. Such a layer may have a thickness, for example, which corresponds to one carbon atom. In particular, the advantage of graphene, for example, lies in its particularly good electrical conductivity and a particularly large surface. In addition, this type of conductive additive is particularly stable chemically. The latter advantages may similarly be achieved for carbon nanotubes and carbon nanofibers. Carbon nanotubes are, for example, microscopically small tubular structures which may form a hexagonal honeycomb-like structure, and which thus represent a tubular structure. Furthermore, carbon nanofibers are fiber-like structures, formed from carbon, which are in the above-described size range.

Within the scope of another embodiment, the active areas may have a size in a range of greater than or equal to 100 nm to less than or equal to 20 μm, in particular in a range of greater than or equal to 100 nm to less than or equal to 10 μm, for example in a range of greater than or equal to 400 nm to less than or equal to 5 μm. In particular, the active areas may thus have a size in the submicron range. The size may be understood in particular to mean a maximum diameter. In this embodiment, the active areas may thus have a particularly large surface, thus allowing particularly large-surface contact of the active centers with the electrically conductive matrix. The rate characteristics may thus be further improved. In addition, in this embodiment a particularly homogeneous distribution of the active areas in the electrically conductive matrix may be achieved, so that the electrode may have a comparable electrochemical effectiveness in generally any area.

With regard to further technical features and advantages of the electrode according to the present invention, explicit reference is hereby made to the discussions in conjunction with the energy store according to the present invention, the method according to the present invention for manufacturing an electrode, the figures, and the description of the figures.

The present invention also relates to an energy store, in particular a lithium-sulfur battery, which includes an electrode equipped as described above. This type of energy store thus includes an electrode, in particular a cathode, having finely distributed active areas in an electrically conductive matrix. Due to this type of design, in particular the rate capability, and thus also the charging and discharging behavior, may be improved. In particular, this type of energy store may be a lithium battery, for example a lithium-sulfur battery.

With regard to further technical features and advantages of the energy store according to the present invention, explicit reference is hereby made to the discussions in conjunction with the electrode according to the present invention, the method according to the present invention for manufacturing an electrode, the figures, and the description below.

The present invention also relates to a method for manufacturing an electrode, in particular a cathode for a lithium-sulfur battery, including the following:
a) providing a mixture which includes an active material, a binder, optionally a suspending agent, and a conductive additive;
b) forming and drying the mixture provided under method step a);
c) producing a mixture which includes the product produced in method step b) and distributed in an electrically conductive matrix;
d) applying the mixture produced under method step c) to a current collector; and
e) optionally drying the product produced in method step d).

Such an example method provides, in a particularly simple manner, an electrode designed in particular as described above, such as a cathode in particular, which is able to provide an improved rate characteristic. The example method steps a) through e) may be carried out in a suitable sequence, and method steps may optionally be carried out together in a single step.

A mixture which includes an active material, a binder, and a conductive additive is provided in a first method step a). For example, the mixture may be composed solely of an active material or an active material mixture, a conductive additive or a conductive additive mixture, and a binder or a plurality of binders. For the case of a lithium-sulfur battery as an example, elemental sulfur, for example, may be used as the active material. In addition, a polyacrylonitrile-sulfur composite material may be particularly suitable as the active material. Examples of suitable conductive additives may be electrically conductive carbon compounds such as carbon black or graphite. In addition or as an alternative to the above-mentioned conductive additives, nanoscale carbon compounds may be provided, likewise to increase the electrical conductivity. Nanoscale carbon compounds may in particular include or be composed of graphene, carbon nanotubes, and/or carbon nanofibers. Polyvinylidene fluoride (PVDF), for example, may be used as the binder.

With regard to the polyacrylonitrile-sulfur composite material, it may be produced in a manner known per se by reacting sulfur with polyacrylonitrile, with an excess of sulfur at an elevated temperature of greater than or equal to 300° C., for example, for a period of 5 h to 7 h, for example. The composite material obtained may subsequently be purified for removal of excess sulfur.

In particular when a polyacrylonitrile-sulfur composite material together with graphene is used, a compound may be obtained in which graphene is bound to the polyacrylonitrile-sulfur composite. Nanoscale graphene (graphene nanosheets (GNS)) may be used which is producible, for example, from graphite oxide in a convention manner, for example as described by J. Wang et al., Polyacrylonitrile/graphene composite as a precursor to a sulfur-based cathode material for high rate rechargeable Li—S batteries, Energy Environ. Sci., 2012, 5, 6966-6972.

In addition, the mixture may optionally contain a suspending agent for suspending the active material, and a solvent for dissolving the binder. This type of solvent or suspending agent may include N-methyl-2-pyrrolidone (NMP), for example.

As one exemplary specific embodiment, sulfur as the active material and an electrically conductive carbon mixture may be suspended in N-methyl-2-pyrrolidone, using a ball mill or a stirring rod, for example. Polyvinylidene fluoride, for example, is subsequently added as a binder which is soluble in the suspending agent.

In such a method for manufacturing an electrode, the mixture provided under method step a) may be formed and dried in a further method step b). In particular, the mixture may thus be processed or formed into a solid or into solid particles having suitable dimensions, which may be suspended, for example, in a subsequent method step. For this purpose, in particular a drying process before, during, or after the forming step may be suitable for drying the mixture and removing it from the solvent or suspending agent, for example. For simultaneous drying and forming, a spray drying process, for example, may be used, whereas for forming after the drying, a granulating process may be advantageous. Thus, a powder in particular is obtained in method step b) which may represent the active areas situated in the finished electrode. Thus, in the electrode to be manufactured, the solid particles thus obtained function as locally delimited active areas or as an active area having a spatially delimited extension. Preferred particle sizes to be produced thus correspond to the preferred extensions of the active areas in the finished electrode. Such particle sizes or maximum diameters of the particles are thus in a range of greater than or equal to 100 nm to less than or equal to 20 μm, in particular in a range of greater than or equal to 100 nm to less than or equal to 10 μm, for example in a range of greater than or equal to 400 nm to less than or equal to 5 μm.

A mixture which includes the product produced in method step b) and distributed in an electrically conductive matrix is produced in a further method step c). Thus, the solid produced in method step b) or the produced solid particles which subsequently function as active areas in the finished electrode are distributed in an electrically conductive matrix or suspended therein. The mixture or the electrically conductive matrix may include a binder, a conductive additive, and optionally a solvent and a suspending agent.

The binder may include carboxymethylcellulose (CMC)/styrene-butadiene rubber (SBR) in a conventional manner, as an example and not limited thereto, whereas the suspending agent may be N-methyl-2-pyrrolidone (NMP) or water, for example, in particular a CMC/water mixture. For a CMC/SBR binder, for example, the CMC may be dissolved in water, and the solution in turn may be used as the suspending agent. The suspending agent used here should not redissolve the binder of the active areas. For this reason, the binder and the suspending agent are preferably selected in such a way that they do not alter the properties of the active area particles, such as in particular conductive additive, active material, and binder.

The conductive additive may also likewise be a conventional electrically conductive material, in particular an electrically conductive carbon compound. Examples include graphite and/or carbon black. Other possible conductive additives also include the above-described nanoscale electrically conductive carbon compounds, such as graphene, carbon nanotubes, and/or carbon nanofibers.

In addition, further active material may be added to the mixture produced in method step c) in order to improve the efficiency of the electrode or of an energy store equipped with this type of electrode. For example, for the case of a lithium-sulfur battery as an example, elemental sulfur, or the above-described polyacrylonitrile-sulfur composite material, for example with bound graphene, may be added.

In a further method step, the mixture produced under method step c) may be applied to a current collector according to method step d). For example, the mixture may be spread onto the current collector, which may be made of metal foil, for example aluminum foil, using a doctor knife.

The product produced in method step d) may be dried in a further method step e). For example, the produced product may be dried for a period of greater than or equal to 30 min to less than or equal to 1.5 h, for example for 1 h, at a temperature of greater than or equal to 80° C. to less than or equal to 120° C., for example a temperature of 100° C., using a heating plate, for example. The previously dried product may be subsequently transferred to a vacuum oven and dried for an additional, longer period, for example for greater than or equal to 10 h to less than or equal to 15 h, for example 12 h, at a lower temperature, for example at a temperature of greater than or equal to 40° C. to less than or equal to 80° C., for example 60° C.

The above-described method is thus characterized in that an active material in a binder, for example, is not applied to a current collector, and the structure thus obtained is not dried, as is common in the related art, but, rather, electrode structures which function as active areas and which include a binder containing an active material and a conductive additive are produced in a first method step, and in a further matrix form the overall structure, and are thus are mounted on a current collector. This results in an electrode structure which has a plurality of small individual electrodes or partial electrodes. The rate capability may thus be significantly improved, in particular with at least comparable capacitance. The performance of an energy store having an electrode manufactured as described above may thus be significantly improved.

Within the scope of one example embodiment, the active material may be comminuted prior to method step a), in particular to obtain particles having a size in a range of greater than or equal to 10 nm to less than or equal to 5 μm; smaller particles may be preferred due to kinetic properties. In this example embodiment, a particularly defined size of particles of the active material, for example the polyacrylonitrile-sulfur composite material, may thus be obtained. In this way the size of the active material particles may be adapted to the intended size of the active areas in a particularly advantageous manner. This is because the subsequent active areas have in particular a plurality of active material particles, so that the size of the active material particles may have an appropriate size, depending on the concentration or penetration into the active area. The particles may be comminuted, for example, by grinding in a mill.

Within the scope of another example embodiment, the mixture provided in method step a) may be comminuted before and/or after method step b), in particular to obtain particles having a size in a range of greater than or equal to 100 nm to less than or equal to 20 μm, in particular in a range of greater than or equal to 100 nm to less than or equal to 10 μm, for example in a range of greater than or equal to 400 nm to less than or equal to 5 μm. In this embodiment it may in particular be ensured that the active areas have a defined size, since the size that is producible here may correspond to the size of the active areas situated in the finished electrode. Due to a particularly defined size of the active areas, the rate capability of an electrode to be manufactured may thus also be designed in a particularly defined manner. Specifically, due to the rate capability being a function of the size of the active areas, among other factors, this method step may in particular be used for allowing the rate capability to be set in a particularly simple and beneficial manner. Comminution of the particles may be carried out, for example, using a granulation process, such as grinding in a mill.

Within the scope of another example embodiment, method step b) may be carried out using a spray drying process. A drying step may be carried out in a particularly advantageous way using a spray drying process, since on the one hand particles of a defined size are obtained by conveying a suspension or solution through a nozzle having a defined diameter, and on the other hand, the small particles may be dried particularly quickly. Thus, in this embodiment, drying may be carried out in only one work step together with setting the size of the active areas.

Within the scope of the present invention, a spray drying process may be regarded as a conventional method from process engineering for drying solutions, suspensions, or pastes. With the aid of a nozzle, the material to be dried may be introduced into a hot air stream of suitable temperature, where it may dry into a fine powder within fractions of a second. The direction of the material to be dried may be aligned with or against the spray jet. In particular, in this type of method, particles having a particularly large specific surface may be formed, which may further improve the rate capability. The pressures and temperatures used may be selected in particular as a function of the selected mixture or its composition.

With regard to further technical features and advantages of the method according to the present invention for manufacturing an electrode, explicit reference is hereby made to the discussions in conjunction with the example electrode according to the present invention, the example energy store according to the present invention, the figures, and the description below.

### BRIEF DESCRIPTION OF THE DRAWINGS

Further advantages and advantageous embodiments of the subject matters according to the present invention are illustrated by the examples and figures and explained below. It is noted that the examples and figures have only a descriptive character, and are not intended to limit the present invention in any way.

FIG. 1 shows a schematic illustration of a partial area of one specific example embodiment of an electrode according to the present invention.

FIG. 2 shows a schematic illustration of a partial area of another specific example embodiment of an electrode according to the present invention.

### DETAILED DESCRIPTION OF EXAMPLE EMBODIMENTS

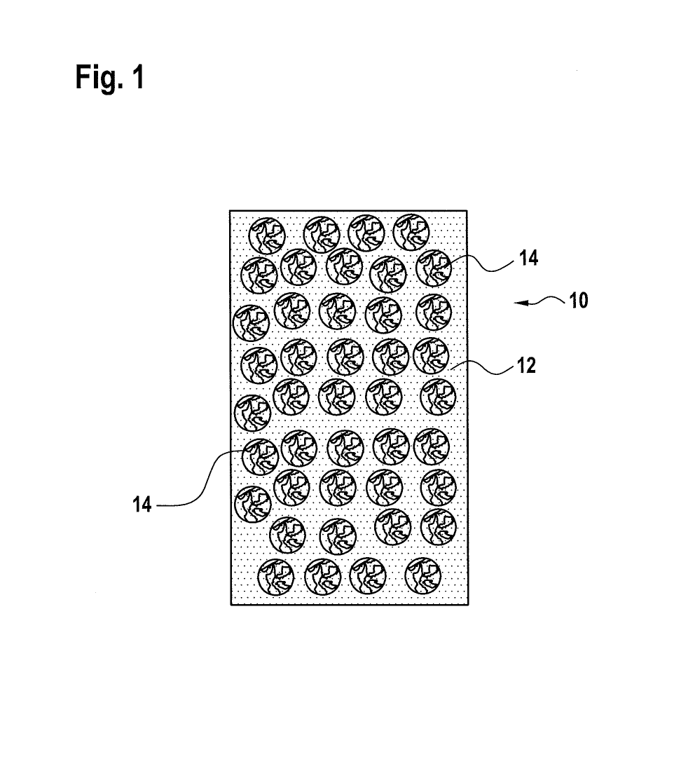

FIG. 1 shows an enlarged schematic view of an electrode 10 for an electrochemical energy store. This type of electrode 10 may be usable in particular as a cathode in lithium batteries, for example lithium-sulfur batteries. Possible fields of application include electrically driven vehicles, computers such as laptops, mobile telephones, smart phones, and other applications.

Electrode 10 may have a thickness in a range, for example, of greater than or equal to 20 μm to less than or equal to 200 μm, and in addition may include an electrically conductive matrix 12. Matrix 12 may contain a binder and a conductive additive. The binder may include polyvinylidene fluoride (PVDF) in a conventional manner. The conductive additive may likewise also be a conventional electrically conductive material, in particular an electrically conductive carbon compound. Examples include graphite and/or carbon black. Further possible conductive additives also include the above-described nanoscale electrically conductive carbon compounds such as graphene, carbon nanotubes, and/or carbon nanofibers.

In addition, locally delimited active areas 14 are situated in the electrically conductive matrix, active areas 14 having an active material, for example sulfur or a polyacrylonitrile-sulfur composite. Furthermore, a conductive additive may be situated in active areas 14. For example, a nanoscale carbon compound may be situated in active areas 16; in particular the nanoscale carbon compound may be bound to the polyacrylonitrile-sulfur composite. In addition, active areas 14 may have a binder, for example carboxymethylcellulose (CMC)/styrene-butadiene rubber (SBR).

Active areas 14 may also have a size or a maximum diameter which is in a range of greater than or equal to 100 nm to less than or equal to 20 μm, in particular greater than or equal to 100 nm to less than or equal to 10 μm, for example greater than or equal to 400 nm to less than or equal to 5 μm.

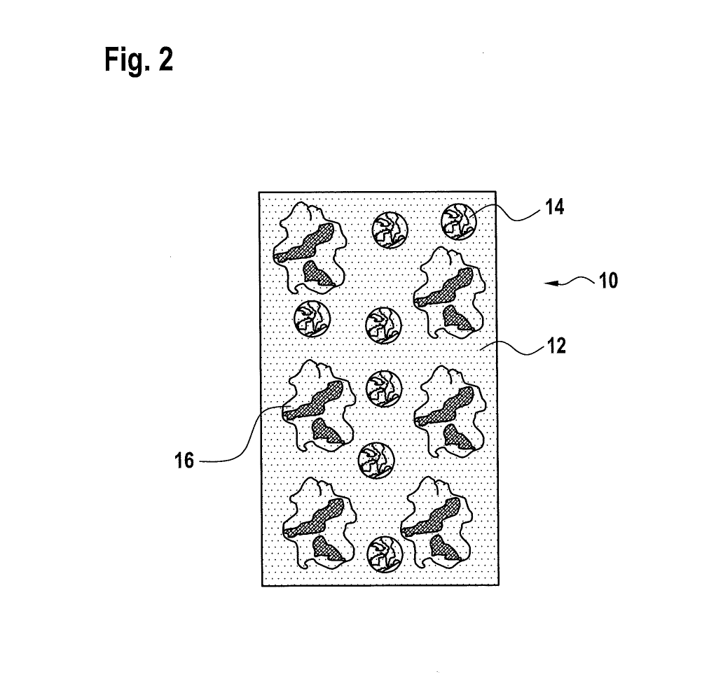

FIG. 2 shows another embodiment of electrode 10. The electrode corresponds for the most part to the electrode described with regard to FIG. 1, so that the same components are provided with the same reference numerals, and generally only the differences from electrode 10 according to FIG. 1 are discussed.

Electrode 10 shown in FIG. 2 has active areas 14, 16 which as a whole are not uniformly formed, and which in particular have different sizes. For example, smaller active area 14 may have a size in a range of greater than or equal to 100 nm to less than or equal to 10 μm, whereas larger active areas may have a size in a range of greater than or equal to 800 nm to less than or equal to 20 μm. The advantage of this embodiment may be that smaller active areas 14 improve the rate capability due to a large surface, for example, and larger active areas 16 may increase the capacitance due to a possibly larger quantity of active material. Thus, the properties such as the capacitance and the rate capability in particular may be settable by suitably adjusting the size of active areas 14, 16, for example.

In addition, active areas 14, 16 may also be uniformly formed with regard to the composition, or a first quantity of first active areas 14 and a second quantity of second active areas and optionally further active areas 16 may be provided.

An example method for manufacturing this type of electrode 10, in particular a cathode for a lithium-sulfur battery, includes the following:
a) providing a mixture which includes an active material, a conductive additive, optionally a suspending agent, and a binder;
b) forming and drying the mixture provided under method step a), in particular using a spray drying process, grinding, or granulation;
c) producing a mixture which includes the product produced in method step b) and distributed in an electrically conductive matrix 12;
d) applying the mixture produced under method step c) to a current collector; and
e) optionally drying the product produced in method step d).

The active material may be comminuted prior to method step a), in particular to obtain particles having a size in a range of greater than or equal to 10 nm to less than or equal to 5 μm. Alternatively or additionally, the mixture provided in method step a) may be comminuted before and/or after method step b), in particular to obtain particles having a size in a range of greater than or equal to 100 nm to less than or equal to 20 μm, in particular in a range of greater than or equal to 100 nm to less than or equal to 10 μm, for example in a range of greater than or equal to 400 nm to less than or equal to 5 μm.

What is claimed is:

1. An electrode for an electrochemical energy store, comprising:
an electrically conductive matrix having a binder and a conductive additive, locally delimited active areas being situated in the electrically conductive matrix, and the active areas having an active material, a conductive additive, and a binder.

2. The electrode as recited in claim 1, wherein the electrod is a cathode for a lithium-sulfer battery.

3. The electrode as recited in claim 1, wherein the active material has a polyacrylonitrile-sulfur composite.

4. The electrode as recited in claim 3, wherein a nanoscale electrically conductive carbon compound is situated in the active areas, the nanoscale carbon compound being bound to the polyacrylonitrile-sulfur composite.

5. The electrode as recited in claim 4, wherein the nanoscale carbon compound contains at least one of graphene, carbon nanotubes, and carbon nanofibers.

6. The electrode as recited in claim 1, wherein the active areas have a size in a range of greater than or equal to 100 nm to less than or equal to 20 μm.

7. An energy store, comprising:
an electrode including an electrically conductive matrix having a binder and a conductive additive, locally delimited active areas being situated in the electrically conductive matrix, and the active areas having an active material, a conductive additive, and a binder.

8. The energy store as rected in claim 7, wherein the energy store is a lithium-sulfer battery.

9. A method for manufacturing an electrode, comprising:
a) providing a mixture which includes an active material, a binder, and a conductive additive;
b) forming and drying the mixture provided in step a);
c) producing a mixture which includes the mixture produced in step b) and distributed in an electrically conductive matrix; and
d) applying the mixture produced in step c) to a current collector.

10. The method as recited in claim 9, wherein step 1) includes providing the mixture with a suspending agent.

11. The method as recited in claim 9, further comprising:
e) drying the mixture applied in step d).

12. The method as recited in claim 9, wherein the active material is comminuted prior to step a) to obtain particles having a size in a range of greater than or equal to 10 nm to less than or equal to 5 μm.

13. The method as recited in claim 11, wherein the mixture provided in step a) is comminuted at least one of before and after step b), to obtain particles having a size in a range of greater than or equal to 100 nm to less than or equal to 20 μm.

14. The method as recited in claim 11, wherein step b) is carried out using a spray drying process.
